(19) United States
(12) Patent Application Publication
(10) Pub. No.: US 2003/0202109 A1
(43) Pub. Date: Oct. 30, 2003

(54) IMAGE SENSING APPARATUS

(76) Inventors: HAYATO UJIIE, TOKYO (JP); TAKASHI FUJII, KAWASAKI-SHI (JP); SEIJI IIDA, TOKYO (JP)

Correspondence Address: MORGAN & FINNEGAN, 345 PARK AVENUE, NEW YORK, NY, 10154

(21) Appl. No.: 09/266,253

(22) Filed: Mar. 11, 1999

(51) Int. Cl. H04N 5/225

(52) U.S. Cl. 348/220.1

(57) ABSTRACT

An image sensing apparatus such as digital still camera and video camera having a driving device moving an image sensing optical system to image sensing and non image sensing regions; and a determination device determining whether the image sensing apparatus is set at least in an image sensing mode, or in an external control mode in which the apparatus is controlled by an external controller unit. The determination device determines an operation of the driving device in accordance with a determination result of the determination device.

### BACKGROUND OF THE INVENTION

The present invention relates to an image sensing device and a recording/reproduction device such as an electronic still camera and a video camera.

There have been proposed compact cameras using silver-salt films with a collapsible lens barrel. Compact cameras are designed to extend the barrel outwardly to a photographable position where the cameras are operable to take a picture when a power supply is turned-on, while retracting the barrel to a retracted position, or collapse position, when the power is turned-off, thus providing portability.

However, such cameras keep a collapsible barrel extended out during powered-on, so that the barrel is ready to be broken during the it is extended out.

### SUMMARY OF THE INVENTION

The present invention has been made in consideration of the aforementioned problem involved in the prior art.

An object of the present invention is to provide an image sensing apparatus that can prevent from a damage of an image sensing optical system caused by being struck with something without deteriorating an operability of the apparatus.

According to one aspect of the present invention, the above object is achieved by providing an image sensing apparatus comprising:

a driving device moving an image sensing optical system to image sensing and non image sensing regions,; and

a determination device determining whether said image sensing apparatus is set at least in an image sensing mode, or in an external control mode in which said apparatus is controlled by an external controller unit,

wherein said determination device determines an operation of said driving device in accordance with a determination result of said determination device.

According to another aspect of the present invention, the above object is achieved by providing an image sensing apparatus comprising:

a driving device moving an image sensing optical system in image sensing and non image sensing regions; and

a determination device determining whether said image sensing apparatus is set at least in an image sensing mode, or in an image reproduction mode,

wherein said determination device determines an operation of said driving device in accordance with a determination result of said determination device.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIGS. 1 and 2 are a block diagram showing the configuration of a digital camera according to a preferred embodiment of the present invention, while FIG. 1 illustrates the camera with an optical system for image sensing being in a retracted position, and FIG. 2 illustrates the digital camera with the optical system in an extended position;

FIG. 3 is a view showing the positional relationship between the barrier and an opening of the camera illustrated in FIG. 1;

FIG. 4 is a front view of a barrier mechanism in a full closed state in the camera illustrated in FIG. 1;

FIG. 5 is a top view of the barrier mechanism shown in FIG. 4;

FIG. 6 is a side view showing the right-hand side of a leaf switch for detecting opening and closure of the barrier of the camera illustrated in FIG. 1;

FIG. 7 is a front view of the barrier mechanism in a full open state in the camera illustrated in FIG. 1;

FIG. 8 is a top view of the barrier mechanism shown in FIG. 7;

FIG. 9 is a front view of the barrier mechanism between the full open and full closed states in the camera illustrated in FIG. 1;

FIG. 10 is a top view of the barrier mechanism shown in FIG. 9;

FIG. 11 is a front view when the barrier mechanism in the full closed state is forced to open in the camera illustrated in FIG. 1;

FIG. 12 is a top view of a mode switching dial of the camera illustrated in FIG. 1;

FIG. 13 is a flow chart showing an operation sequence of a CPU for opening/closing the barrier of the illustrated in FIG. 1;

FIG. 14 is a flow chart showing another operation sequence of the CPU a flow chart CPU for opening/closing the bier of the illustrated in FIG. 1, which flowchart being similar to FIG. 13 except steps enclosed by the broken lines; and

FIG. 15 is a flow chart showing yet another operation sequence of the CPU a flow chart CPU for opening/closing the barrier of the illustrated in FIG. 1, which flowchart being similar to FIG. 13 except steps enclosed by the broken lines.

### DETAILED DESCRIPTION OF THE INVENTION

A preferred embodiment according to the present invention will be described in detail below with reference to the accompanying drawings.

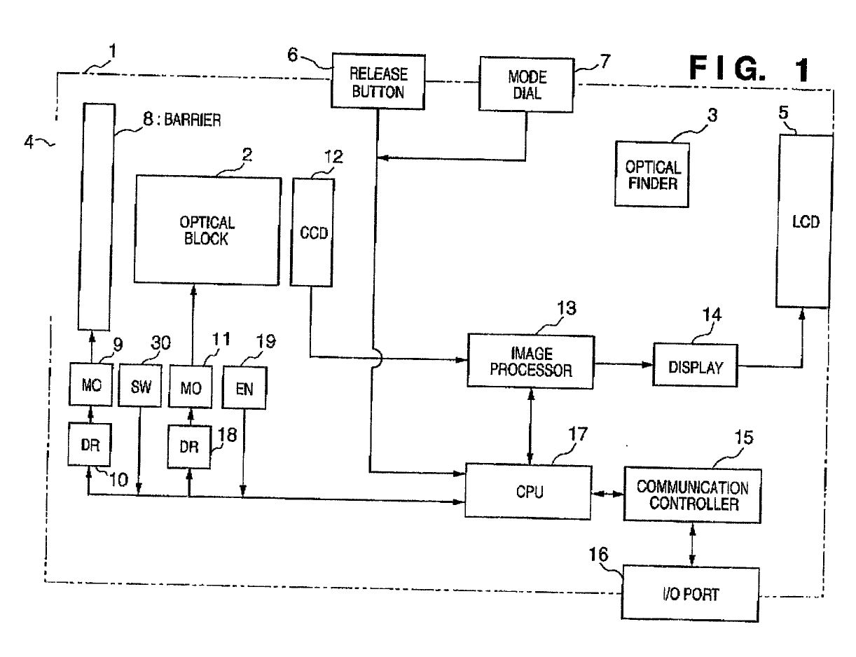

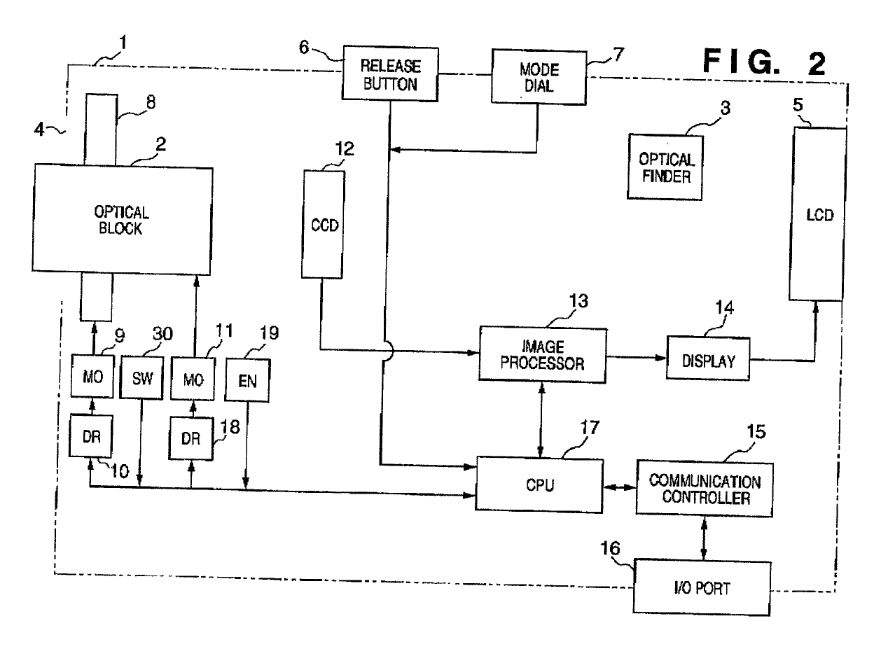

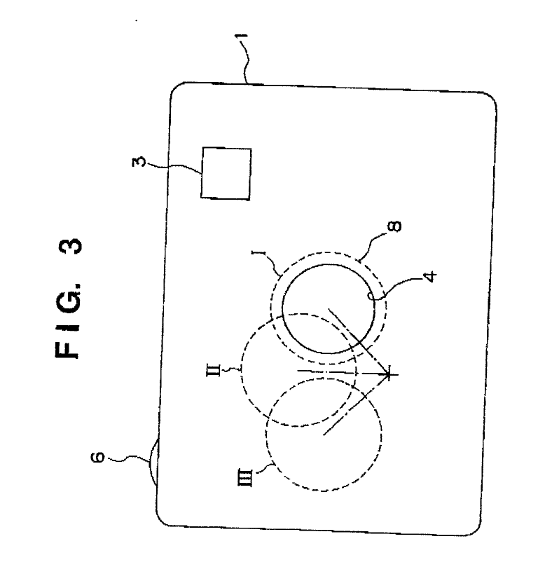

FIGS. 1 and 2 are a block diagram showing the configuration of a digital camera according to a preferred embodiment of the present invention. FIG. 1 illustrates the camera of FIG. 1 with an optical system for image sensing being in a retracted position. FIG. 2 illustrates the digital camera with the optical system in an extended position. FIG. 3 illustrates the arrangement of a barrier and opening of the camera in FIG. 2.

In FIGS. 1 through 3, reference numeral 1 denotes a camera main body; 2, an optical block including a lens and lens barrel which comprise an optical system, an optical finder; 11, a motor (MO) for driving the optical system to an image sensing region in which images can be sensed and to a retracted region (non-image sensing region) in which the optical block is housed within the body. The motor 11 also drives the optical block 2 for zooming while the block 2 is extended in the image sensing region.

Returning to FIGS. 1 to 3, 18 denotes a driver circuit (DR) for controlling driving of the motor 9; 19, an encoder (EN) for detecting the position of the block 2; 4, an opening through which the block 2 is extended from the retracted region to image sensing region which is out of the camera body 1; 5, an LCD (Liquid Crystal Display) for displaying live images and reproduced images; 6, a release button for starting image-sensing. 7 denotes a mode dial which is manually operated by the user to switch modes (to be described later) of the camera. The user can operate the switch 7 from exterior of the camera.

Reference numeral 8 denotes a barrier for covering the opening 4; 9, a motor (MO) for driving the barrier 8; 10, a driver (DR) for controlling driving by the motor 9; 30, a switch unit which detects opening and closure of the barrier 8; 12, a CCD for converting an object image formed by the optical block 2 into an electrical signal; 13, an image processor for processing an output signal from the CCD 12 to produce an image signal; 14, a display unit for displaying the image signal from the image processor 13 on the LCD 5; 15, a communication controller for controlling communication with an external control device (not shown) such as a personal computer; 16, an I/O port as an interface to the external control device; and 17, a CPU for controlling operations of these units. The CPU 17 also records, as photographic images, the image signal from the image processor 13 on the internal memory of the CPU 17.

To explain the positional relationship between the barrier 8, the main body 1, and the optical block 2, the way the barrier 8 moves upon sensing will be described below with reference to FIG. 3.

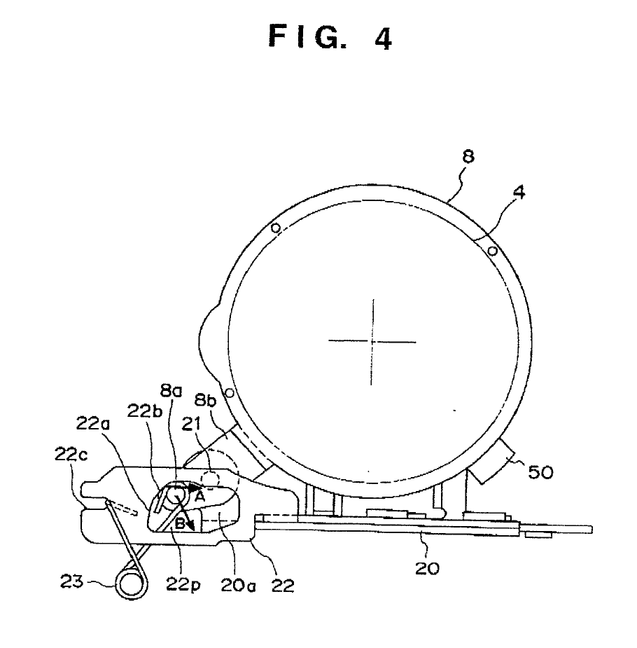

The broken lines in FIG. 3 indicate the lens barrier 8 which pivots on a shaft 21 (to be described later with reference to FIG. 4). Referring to FIG. 3, I indicates a full closed state (to be referred to as a full close position hereinafter) of the opening 4, in which state the barrier 8 fully covers the opening 4; III, a full open state (to be referred to as a full open position hereinafter) of the opening 4, in which state the barrier 8 retracts from the opening 4 and the opening 4 is fully open; and II, a state in which the barrier 8 is intermediate between the full close position I and the full open position III.

The barrier 8 naturally has a larger diameter than the opening 4. Therefore, when the barrier 8 is in the full close position I, the barrier 8 fully covers the opening 4 to prevent foreign matter from entering the camera, user's fingers from touching the lens surface, and external light from entering the camera. When the barrier 8 is in the full open position III, the barrier 8 is completely separated from the opening 4 and hence does not cover the sensor surface.

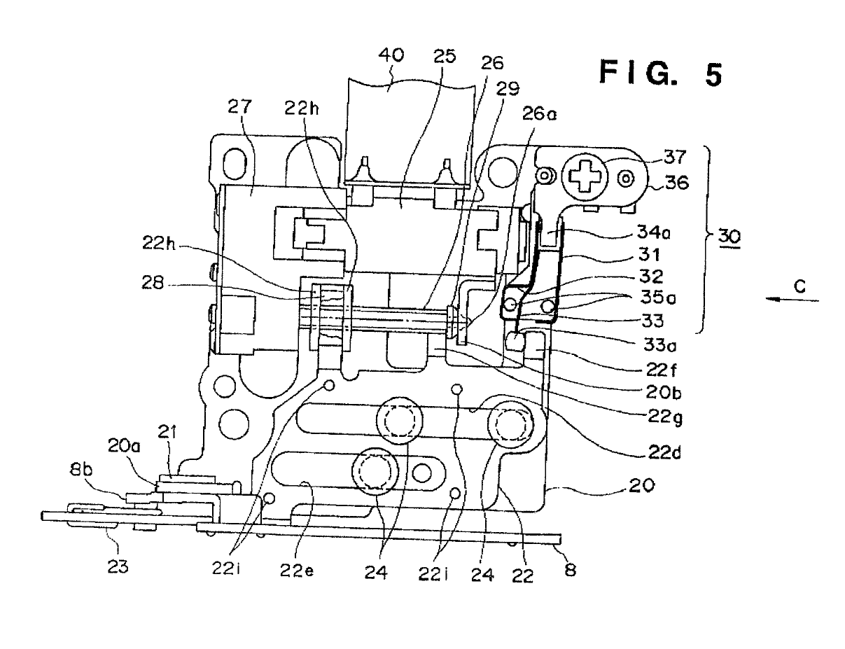

A barrier mechanism as a driving system and transmission system of the barrier 8 of the embodiment will be described below with reference to FIGS. 4 and 5.

FIG. 4 is a front view of the barrier mechanism when the camera is viewed frontways with the barrier 8 in the full close position. FIG. 5 is a top view of the barrier mechanism in FIG. 4. For the sake of simplicity of explanation, a driving mechanism such as a motor is not shown in FIG. 4, and the lens barrel is not shown in FIG. 5.

First, the barrier mechanism will be described below with reference to FIG. 5.

In FIG. 5, reference numeral 20 denotes a barrier base for holding the barrier 8 so it is free to pivot. This barrier base 20 also holds parts pertaining to bier driving (to be described later). Reference numeral 20a denotes an upright bent portion of the barrier base 20. A shaft 21 is caulked to a tag 8b of the barrier 8 with the upright bent portion 20a between them, so the barrier B is free to pivot.

Reference numeral 22 denotes a slider as a transmitting member; and 22d and 22e, slide grooves. Shafts 24 are caulked to the barrier base 20 with the slider 22 between them, thereby holding the slider 22 to be slidable in the lateral direction of the paper. The spacing between the shank of each shaft 24 and the slide groove 22d is minimized. This minimizes play of the slider in the longitudinal direction of the paper of FIG. 5.

The heads of the shafts 24 suppress play in the direction normal to the paper of FIG. 5. The width of the slide groove 24e is made much larger than the diameter of the shaft 24, so the shaft 24 does not come into slidable contact with the slide groove 22e. This prevents the slider 22 and the shaft 24 from interfering with each other. Pawls 22f and 22g protrude from the slider 22 so as to turn on and of f a leaf SW (to be described later). A U-shaped upright bent portion 22h receives force transmitted from a nut 28 inserted between two upright plates of the upright bent portion 22h. Projections 22i of the slider 22 project into the paper of FIG. 5 and have spherical points. These projections 22i bring the barrier base 20 and the slider 22 into point contact, at four points, with each other, and this decreases the sliding resistance between them.

Reference numerals 25 and 26 denote a motor and screw, respectively, as a driving source of the barrier 8. The rotating speed of this motor 25 is reduced by gears (not shown) in a bear box 27. In the embodiment, a stepping motor is used as the motor 25.

A tip 26a of the screw 26 is rotatably supported by an upright bent portion 20b of the barrier lass 20. A washer 29 with a tapered surface is inserted between the screw 26 and the bent portion 20b. A nut 28 meshes with the screw 26. A whirl-stop (not shown) of the nut 28 and a whirl-stop receiver (not shown) of the slider 22 engage with each other to regulate the rotation. A flexible circuit board 40 supplies electric power to the motor 25. When the motor 25 rotates, the speed of the rotation is reduced, and this rotation is transmitted to the screw 26, i.e., rotates the screw 26. When the screw 26 is thus rotated, the upright bent portion 22h moves sideways in the plane of the paper, and the slider 22 connected to the upright bent portion 22h also moves sideways in the plane of the paper. This sideway movement of the slider is the source of pivoting force of the barrier 8.

A leaf SW 30 as an opening/closing detecting means includes leaf contacts 31 and 32 and a common contact 33. The leaf contact 31 detects that the barrier 8 comes to the full open position. The leaf contact 32 detects that the barrier 8 comes to the full close position. When the slider 22 moves sideways as described above, the pawls 22f and 22g of the slider 22 move an insulating portion 33a at the end of the common contact 33 sideways. When the insulating portion 33a moves sideways, the common contact 33 comes in contact with the leaf contact 31 or 32. By detecting a signal from the leaf contact 31 or 32, it is possible to determine whether the common contact 33 is in contact with the leaf contact 31 or 32, the slider 22 has moved to the left or right, and the barrier 8 is in the full close or full open position.

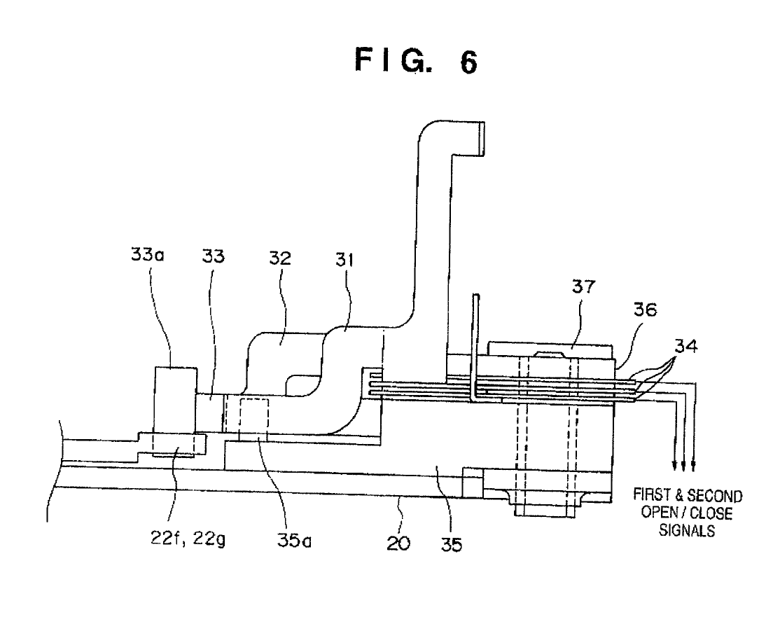

The end portion 33a of the common contact 33 is insulated because a metal material is used as the slider 22 and the common contact 33 in the embodiment. The leaf contacts 31 and 32 are precharged to the left and right, respectively, in the plane of the paper and so positioned that their end portions press against a boss 35a. Details of the leaf SW 30 will be described later with reference to FIG. 6.

The barrier mechanism will be described below with reference to the front view of FIG. 4.

The slider 22 moves to the right (in the direction of an arrow A) in the plane of the paper by the rotation of the motor 25. Consequently, a tapered surface 22a or 22b formed inside an opening 22p pushes a pin 8a formed on the tongue-shaped piece 8b of the barrier 8 in the direction of an arrow B in FIG. 4, thereby opening the barrier 8. One end of a bias spring 23 as an elastic member in the preferred embodiment is locked by the pin 8a through the gap between the slider 22 and the barrier tongue-shaped piece 8b. The other end of this spring 23 is locked in a notch 22c of the slider 22. The bias spring 23 is so biased (precharged) as to bring its two end portions close to each other. In FIG. 4, therefore, the barrier 8 is forced to rotate clockwise around the shaft 21. Reference numeral 22p denotes a hole for allowing the pin 8a to move.

A stopper 50 abuts against the barrier 8 to regulate its full close position. In the embodiment, this stopper 50 is formed by protruding a portion of an optical block (not shown). However, the stopper 50 can also be formed on the main body cover or the barrier base 20.

FIG. 6 shows details of the construction of the leaf SW 30 when the barrier mechanism shown in FIG. 5 is viewed in the direction of an arrow C in FIG. 5.

In FIG. 6, reference numeral 34 denotes Mylar sheets for insulation. These three Mylar sheets 34 insulate the leaf contacts 31 and 32 from each other and insulate each of these leaf contacts 31 and 32 from the barrier base 20. A leaf base 35 fixes the leaf contacts 31 and 32 to the barrier base 20. A press plate 36 helps a machine screw 37 fix the leaf contacts 31 and 32, the Mylar sheets 34, and the leaf base 35. A shown in FIG. 6, the leaf contacts 31 and 32 are so formed that their proximal end portions are away from the barrier base 20 and their distal end portions are close to the barrier base 20. This is to prevent interference between the motion of the common contact and each leaf contact.

The end portions of the leaf contacts 31 and 32 extend outward while being insulated from each other by the Mylar sheets 34 and output first and second open/close signals, respectively. The CPU 17 shown in FIG. 2 detects these signals.

Operations of opening and closing the barrier 8 will be described below with reference FIGS. 4, 5, and 7 to 10.

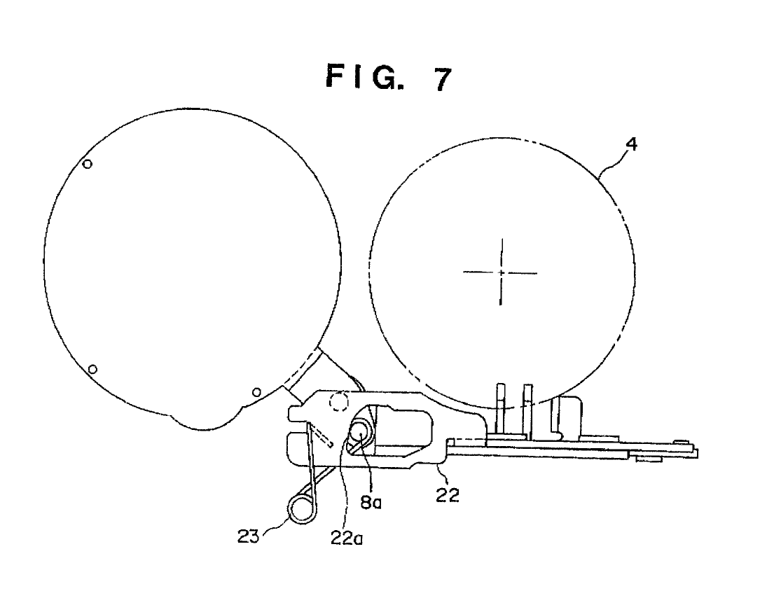

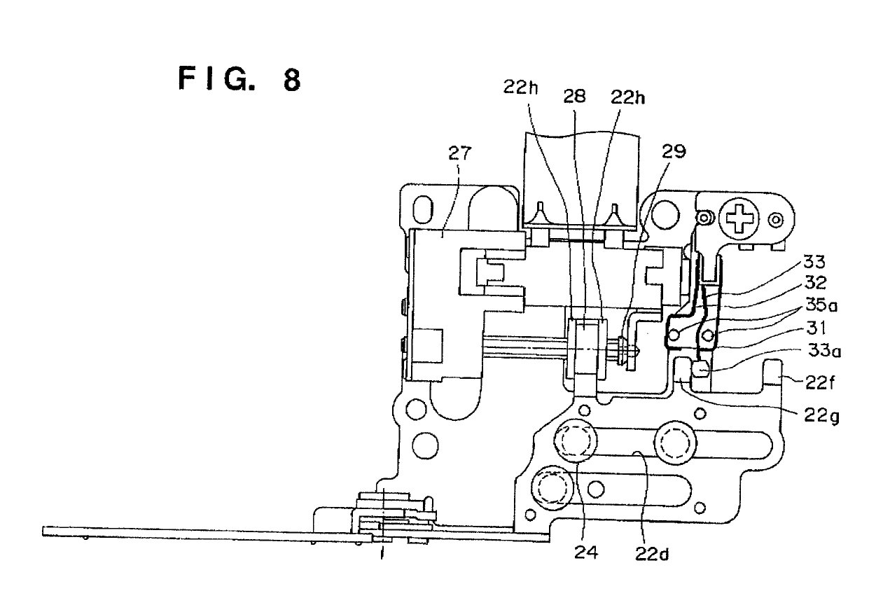

FIGS. 4 and 5 are front and top views, respectively, of the barrier mechanism with the barrier 8 not open (fully closed) (in the position I shown in FIG. 3) when the power supply of the camera is OFF or the camera is in a reproduction mode (to be described later). FIGS. 7 and 8 are front and top views, respectively, of the barrier mechanism with the barrier 8 fully open (in the position III shown in FIG. 3) in a sensing mode or PC mode (to be described later).

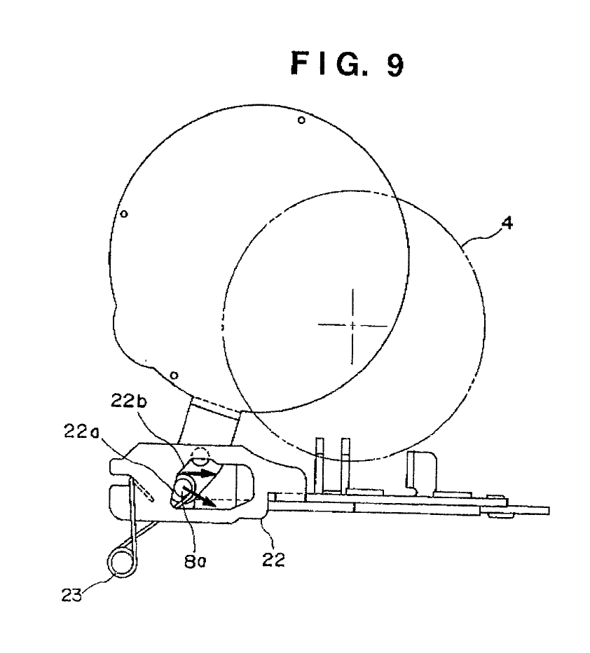

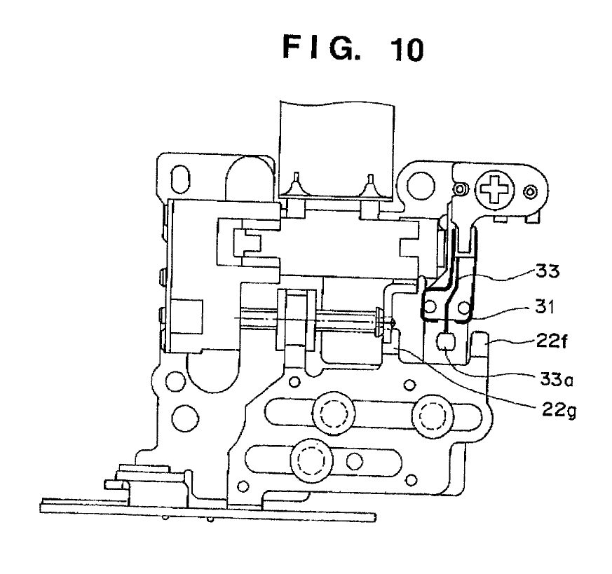

FIGS. 9 and 10 are front and top views, respectively, of the barrier mechanism in the intermediate position (the position II shown in FIG. 3) between the full close and full open positions.

First, the state of the barrier 8 in each drawing will be described.

FIG. 9 shows the barrier 8 in the intermediate position II between the full close position I and the full open position III. When the barrier 8 is in the position II, as shown in FIG. 10, the common contact 33 is not in contact with either of the leaf contact 31 or 32. In this state, the CPU 17 shown in FIG. 2 detects that the barrier 8 is located between the full open position III and the full close position I on the basis of the first and second open/close signals from the switch 30. The pin 8a presses against the tapered surface 22a or 22b by the precharging force from the spring 23. As the slider 22 further moves to the left or right in the plane of the paper, the barrier 8 pivots accordingly.

Referring to FIGS. 4 and 5, if the pawl 22f of the slider 22 pushes the insulating portion 33a of the common contact 33 to bring the common contact 33 into contact with the leaf contact 32, the second open/close signal outputs a logical value “1”, and the first open/close signal outputs a logical value “2”. On the basis of these logical values of the signals, the CPU 17 detects that the barrier 8 is in the full close position I.

In the state shown in FIG. 4, the barrier 8 is regulated by the stopper 50 and hence cannot pivot any further. However, the slider 22 moves to the left in the plane of the paper more than that, so the tapered surface 22a of the slider 22 and the pin 8a are separated. Accordingly, the spring 23 is further charged.

Referring to FIGS. 7 and 8, if the pawl 22g of the slider 22 pushes the insulating portion 33a of the common contact 33 to bring the common contact 33 into contact with the leaf contact 31, the CUP 17 (FIG. 2) detects that these two contacts 33 and 31 are closed and that the barrier 8 is in the full open position III. In this state, the pin 8a keeps pressing against the tapered surface 22a of the slider 22.

A series of operations of the barrier 8 will be described below.

In the state shown in FIGS. 4 and 5, the spring 23 is charged as described previously. Therefore, the barrier 8 presses against the stopper 50 and hence can be reliably held closed regardless of the posture of the camera or vibrations while the camera is carried. A process of opening the barrier 8 by driving the motor 25 Eros this state will be described. Assume that rotation of the motor 25 in a direction in which the brier 8 is opened is forward rotation.

Referring to FIG. 5, when the motor 25 rotates forward, the speed of the rotation is reduced by a pinion gear and intermediate gear (not shown), and the driving force is transmitted to a screw gear (not shown) formed integrally with the screw 26.

The smaller the screw diameter, the more efficiently the axial torque can be converted into axial force. When the screw diameter is decreased, however, hardly any difference can be maintained between the screw diameter and the screw tip diameter because the diameter of the screw tip 26a is limited.

Consequently, threads cannot be smoothened by cutting tapered surfaces at the end face of the screw tip 26a. So, the end faces of rough threads slide on the upright bent portion 20b to produce large resistance, or the two members scrape of f each other. Therefore, the washer 29 is inserted between the screw 26 and the upright bent portion 20b to prevent the screw 26 from directly sliding on the upright bent portion 20b. Additionally, a washer surface that comes into contact with the screw 26 is roughened, and a washer surface which slides on the upright bent portion 20b is smoothened and tapered. This makes the washer 29 rotate together with the screw 26. This is to prevent abrasion by allowing the smooth surface to slide.

When the screw 26 rotates, the nut 28 is also bound to rotate. However, a whirl-stop is formed on the nut 28 as described earlier, and this converts the torque of the screw 26 into axial force which feeds the nut 28 to the right in the plane of the paper. The nut 28 pushes the upright bent portion 22h of the slider 22 to move the slider 22 to the right. When the slider 22 moves a slight distance, the common contact 33 and the leaf contact 32 move away from each other. Consequently, the leaf contact 32 does not close to either contact, and the CPU 17 detects that the barrier 8 is in the intermediate position between the full close and full open positions.

As shown in FIG. 4, when the slider 22 starts moving, the pin 8a and the tapered surface 22b are separated. Accordingly, the barrier 8 still presses against the stopper 50 by the charging force even when the slider 22 moves. After the slider 22 moves to bring the tapered surface 22a into contact with the pin 8a, the tapered surface 22b pushes the pin 8a, and the barrier 8 starts pivoting.

The rotating direction of the pin 8a from the full close position has a large angle to the moving direction of the slider 22. Therefore, when the barrier 8 starts opening, the force from the slider 22 is not efficiently transmitted to the barrier 8, so large driving force is necessary. This means easy occurrence of step-out since the motor 25 is a stepping motor.

To prevent this, the contact surface 22b which contacts at the beginning of opening makes large angle with the moving direction of the slider 22, thereby bringing the direction of force applied to the pin 8a close to the moving direction of the pin 8a. Consequently, the force is efficiently transmitted to allow the barrier 8 to start opening smoothly and reliably. In the preferred embodiment, the angle of the tapered surface 22b is set to about 45°. Also, if the motor 25 comprises a DC motor, decreasing the load decreases the current of the motor 25 and hence has an effect of saving energy.

Additionally, when the motor 25 is a stepping motor, the rotating speed and torque of the motor 25 are low immediately after the motor 25 starts rotating, so the motor 25 is unstable in this stage. At the beginning of opening, therefore, the slider 22 does not contact the barrier shaft 8a to allow the motor 25 to drive with low load. When the motor 25 stabilizes, the motor 25 is made to open the barrier 8. This prevents step-out of the stepping motor 25 and allows the motor 25 to operate smoothly and reliably.

Also, at the onset of opening the slider 22 is biased by the charging force of the spring 23 in the direction in which the barrier 8 opens. Since this force reduces the load at the beginning of opening, the harrier 8 can start opening more smoothly.

FIGS. 9 and 10 show the state in which the barrier 8 is in the intermediate position II between the full close and full open positions.

As shown in FIG. 9, after the barrier 8 starts opening and moves for a while, the contact surface 22a of the slider 22 is less tapered and is nearly perpendicular to the moving direction of the slider 22. This is because the moving direction of the pin 8a comes close to the moving direction of the slider 22, so the force can be transmitted more efficiently when the taper angle is reduced.

When the barrier 8 is driven, the charging force of the spring 23 does not produce any load. That is, the charging force is kept substantially constant because the spring 23 moves together with the slider 22 and the barrier pin 8a and the opening angle of the spring 23 is almost fixed during the movement. However, when the slider 22 moves after the barrier 8 abuts against the stopper 50 while closing, the load increases because the spring 23 is further charged.

FIGS. 7 and 8 show the completely opened (full open) state of the barrier 8.

When driving is continued from the intermediate position shown in FIGS. 9 and 10, the pawl 22g of the slider 22 pushes the common contact 33 and brings it into contact with the leaf 31. When the CPU 17 (shown in FIG. 2) detects closing of the contact, the CPU 17 stops motor 25 to terminate the opening operation of the barrier 8. The barrier 8 is so designed as to stop in a position where it is well retracted from the opening 4.

The stop position of the barrier 8 depends upon the timing of the leaf SW 30 described previously. This timing is largely influenced by various error factors such as the dimensional accuracy and mounting accuracy of the leaf contacts 31 and 32, dimensional accuracy of the pawls of the slider 22, positional accuracy of the tapered surface of the slider 22, positional accuracy of the pint 8a, and accuracy of the positional relationships between the individual components. Since the stop position of the barrier 8 is well separated from the opening 4, the aforementioned parts accuracy can be lowered, and this reduces the parts cost.

The leaf contacts 31 and 32 and the common contact 33 are made of a metal plate about 0.1 mm thick. Then this metal plate is processed into complicated shapes as in the embodiment, toe dimensional accuracy of each part is lowered. Hence, the leaf contacts 31 and 32 are positioned by making their end portions press against the boss 35a of the leaf base 35.

Accordingly, if the lengths of the end bent portions of the leaf contacts 31 and 32 are processed with high accuracy, the end portion of each contact can be accurately positioned with respect to the pawl of the slider 22. This is because the leaf base 35 is a molded product, so the boss can be formed with high positional accuracy by molding.

If the leaf SW 30 cannot detect the full open position for some reason while the barrier 8 is opening, or, if the motor 25 does not stop driving although the leaf SW 30 detects the full open position, the slider 22 may keep moving. In the worst case, the end portion of the slide groove 22d bites the shaft 24, or the upright bent portion 22h of the slider 22 abuts against the washer 29 or the gear box 27 to cause the screw 26 and the nut 28 to interfere with each other. If this is the case, neither forward rotation nor reverse rotation is possible. To prevent this, in the embodiment the common contact 33 abuts against a boss 35a (FIG. 5) to produce large load, preventing any further movement of the slider 22. The same arrangement is used on the closing side.

If disturbance is inflicted on the barrier 8 while it is opening, e.g., if a user holds the barrier 8 with his or her finger, the load acts on the motor 25 via the screw 26 and the like because the slider 22 is directly pushing the pin 8a. In the worst case, the motor 25 steps out. A stepping motor can originally control the range of movement of the barrier 8 by the number of driving steps. However, once a stepping motor steps out, the position of the barrier 8 becomes unknown, so the leaf SW 30 for detecting the full open position is necessary to recover after that.

The barrier 8 is closed from the state shown in FIGS. 7 and 8.

Referring to FIGS. 7 and 8, when the slider 22 moves, the spring 23 is biasing the pin 8a, so the pin 8a pivots the barrier 8 while it presses against the tapered surface 22a. When driving is continued, the barrier 8 abuts against the stopper 50, and the pivotal movement is regulated. In this state, the leaf contact 32 for detecting full closure and the common contact 13 are not in contact with each other yet.

When driving by the motor 25 is further continued, the pawl 22f of the slider 22 pushes the common contact 33 to bring it into contact with the leaf contact 32. The CPU 17 (FIG. 2) detects closure of the contact and stops driving by the motor 25. Consequently, the state returns to the full close position I shown in FIGS. 4 and 5. Since the opening angle of the spring 23 is large, the spring 23 is further charged. The leaf contacts 33 and 32 are so designed as to close after the barrier 8 is stopped and driven a predetermined amount. Therefore, even if the timing of conduction slightly changes due to specific parts accuracy of the parts as mentioned earlier, the barrier 8 is reliably closed.

If the barrier 8 is held by a finger or the like while moving in the closing direction, the slider 22 keeps moving, against the biasing force of the spring 23, to the left in the plane of the paper while further charging the spring 23. If this driving force is sufficiently strong, the slider 22 moves until the leaf SW 30 makes a circuit, and then stops driving.

Afterward, when the finger is removed from the barrier 8, the charging force of the spring 23 returns the barrier 8 to the full close position I. If the driving force is insufficient, the motor 25 steps out and hence cannot stop driving in the full close position as in the opening operation. Accordingly, the leaf SW 30 for detecting the full close position is necessary.

Caution should be exercised as follows in stopping motor driving in the above explanation.

When the stepping motor 25 is abruptly stopped, it often stops with the phases of its internal coil and magnet closest to each other. Therefore, the stepping motor 25 sometimes stops after rotating in the reverse direction to the direction before the stoppage. In this state, if driving of the motor 25 is stopped instantaneously after the contact 31 of the leaf SW 30 makes a close circuit with the contact 32, the slider 22 may move a slight distance in the reserve direction to open the leaf contacts 31 and 32. Accordingly, driving is continued for a predetermined time period after the moment that the contact 31 is close with the contact 32, so as to slightly charge the leaf contacts 31 and 32, and then driving by the motor 25 is stopped. In this way the leaf contacts 31 and 32 reliably close.

A state in which the barrier 8 in the full close position is forced to open will be described below.

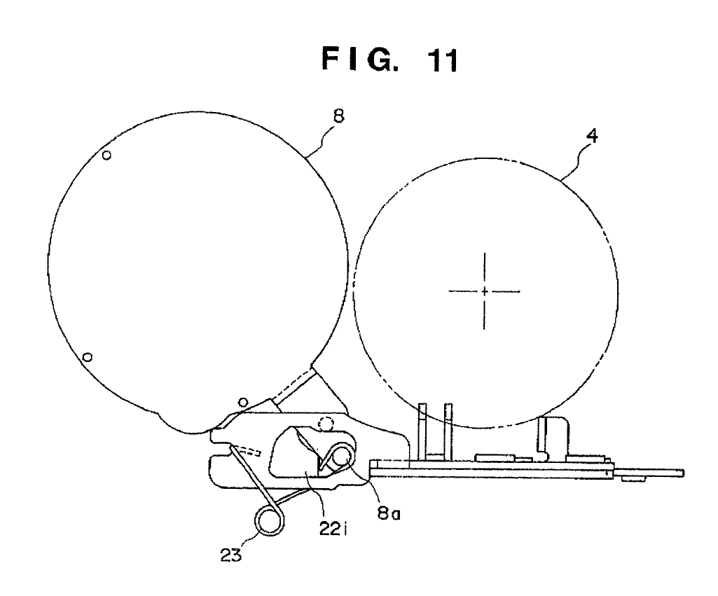

FIG. 11 shows the state in which the barrier 8 in the full close position is forced to open. Even if the barrier 8 is completely retracted from the opening 4, no external force directly acts on the driving system because the spring 23 charges. Also, the hole 22i is formed in the slider 22 to allow movement of the pin 8a which pivots together with pivot of the barrier 8. Therefore, no excessive force is inflicted on the barrier 8 or the slider 22.

The spring 23 can bias the barrier 8 in the opening direction, which is opposite to the closing direction, as in the embodiment. When external load on the barrier 8 is taken into consideration, however, it is desirable to bias in the closing direction as in the embodiment.

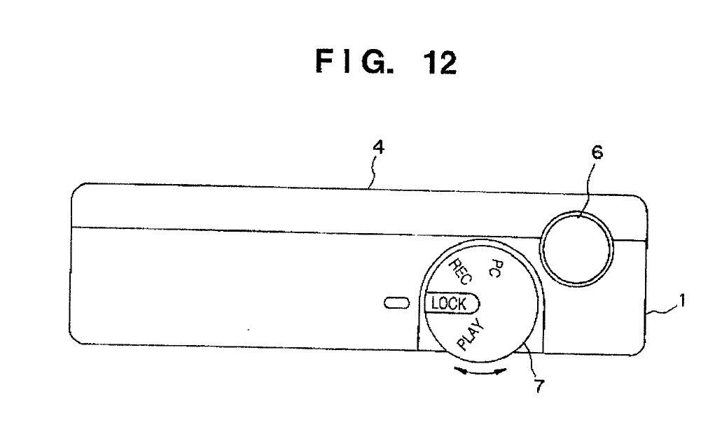

Next, camera modes will be described with reference to FIG. 12.

FIG. 12 is a top view of the mode dial 7 provided on the upper surface of the camera. The camera of the embodiment has a LOCK mode in a power OFF state, a REC (recording) mode as a sensing, a PLAY (reproduction, display) mode as a reproduction mode, and a PC mode as a controllable mode. A means for switching these modes is of course not limited to the dial switch.

The respective modes in FIG. 12 have the meanings as follows.

LOCK mode: power is OFF.

REC mode: sensing by which depression of the release button 6 (FIGS. 2 and 3) is detected and an image is input from the CCD 12 (FIG. 2) is possible. More specifically, a user can sense an object awhile monitoring a live image (successively input by the CCD 12) displayed on the LCD 5 or sense an object while checking the object through the optical finder with the LCD 5 turned OFF.

PLAY mode: reproduction by which image data stored in a storage medium (not shown) is read out and displayed on the LCD 5 or an external display device is possible.

PC mode: the camera can be connected to an external computer. For example, the camera is connected to an external computer and exchanges image data with the computer, or the computer instructs the camera to sense.

The opening/closing operation of the barrier 8 in a camera with the above-mentioned modes will be described below.

<Control Procedure> . . . First Example

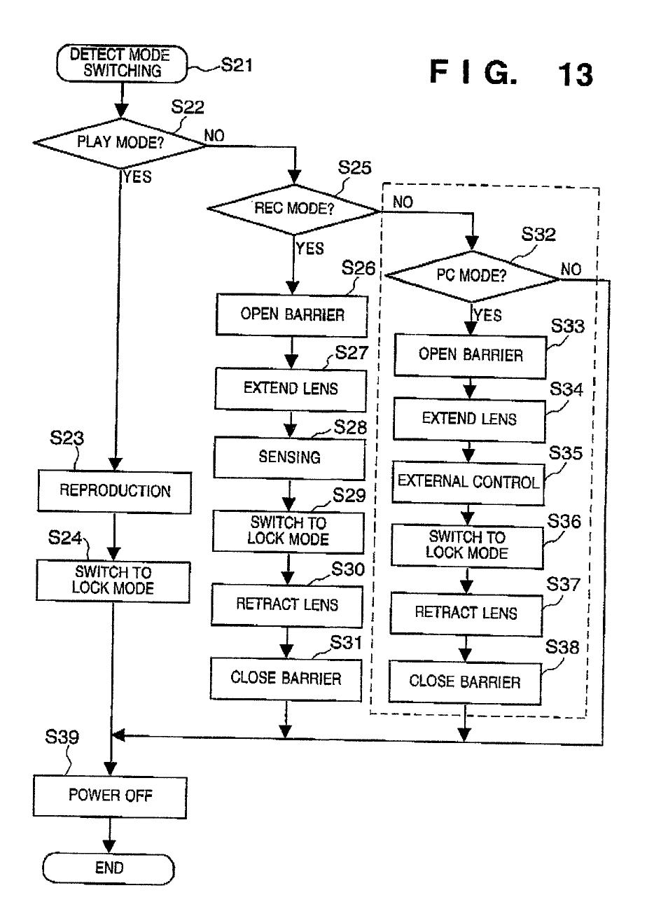

FIG. 13 is a flow chart showing the opening/closing operation sequence of the barrier 8 of a camera having the REC mode, PLAY mode, and PC mode, which sequence id controlled by the CPU 17.

In step S21, the CPU 17 detects switching by the mode dial 7. If the PLAY mode is set (step S22), the CPU 17 displays a recorded image on the LCD 5 or the like (step S23). If the mode is switched to the LOCK mode after that (step S24), the CPU 17 turns off the power supply (step S39) and completes the operation. Thus, in the PLAY mode, operations are not made to open the barrier 8 and to extend the optical block 2.

In step S21, switching of the mode dial 7 is detected. Where the mode is switched into the REC mode, the control advances through step S25 to step S26 where the barrier 8 is driven to open through the driver 10 by the motor 9. When it is detected by the switches 30 that the barrier is open, the motor is controlled to be driven by the driver 18 while the optical block 2 is driven to the image sensing region (as illustrated in FIG. 2) out of the retracted region (non-image sensing region) as illustrated in FIG. 1, in step S27. Then, after the optical block 2 is further extended for zooming, when the release button 6 is depressed, a recording operation starts with a focus adjustment being made (step S28).

When it is detected in step S29 that the mode is changed to the LCK mode, the optical block 2 is pulled in the retracted position by the motor 11 driven by the driver 18 (step S30), as illustrated in FIG. 1. When the encoder 19 detects that the optical block 2 is positioned within the retracted region (FIG. 1), barrier 8 is driven to be closed by the motor 9 through the driver 10 (step S31), then the operation terminates with the power being turned off (step S39).

When it is detected that the mode dial 7 is switched into PC mode in step S21, the control advances to step S32, the barrier 8 is open in step S33 as in the REC mode, then, the optical block 2 which is in the retracted region is in step S34 extended to the image sensing region. Then, the camera is placed in a status where controls can be accepted from the external computer (step 35). The camera placed in the status is capable of transceiving image data with the external computer, or of picking up images in accordance with an image sensing instruction signal from the external computer, or the like, during which the optical block 2 is kept in the extended region, while the barrier 8 is kept open, which is needless to say.

When the mode is changed into LOCK mode (step S36), the block 2 which is now in the extended region is pulled in the retracted region (FIG. 1) in step S37, the barrier 8 is closed in step S38, and the power is turned off in step 39, as in the REC mode.

As set forth above, the camera of the embodiment opens the barrier 8 to extend the optical block 2 immediately when it is switched in the REC mode, thus enabling an instantaneous image sensing.

On the other hand, when it is switched in the PLAY mode, the barrier 8 is not open and the block 2 is not extended. Therefore, the photographing lense of the block 2 can be prevented from being contaminated, and/or being damaged, or the block 2 can be prevented from being broken by being struck with something.

Further, when the camera is switched into the PC mode, the barrier 8 is immediately open, and the optical block 2 is extended out from the retracted region to the extended region These place the camera ready for accepting image sensing initiating instruction from the external computer accompanied by an immediate image-sensing. Thus, the user does not miss good opportunities for photographs, which provides a quick response camera.

If the CPU 17 detects the LOCK mode (NO decision) in step S32 after detecting the status of the dial 7, the CPU 17 turns off the power supply (S39), and then terminates the control.

<Control Procedure> . . . Second Example

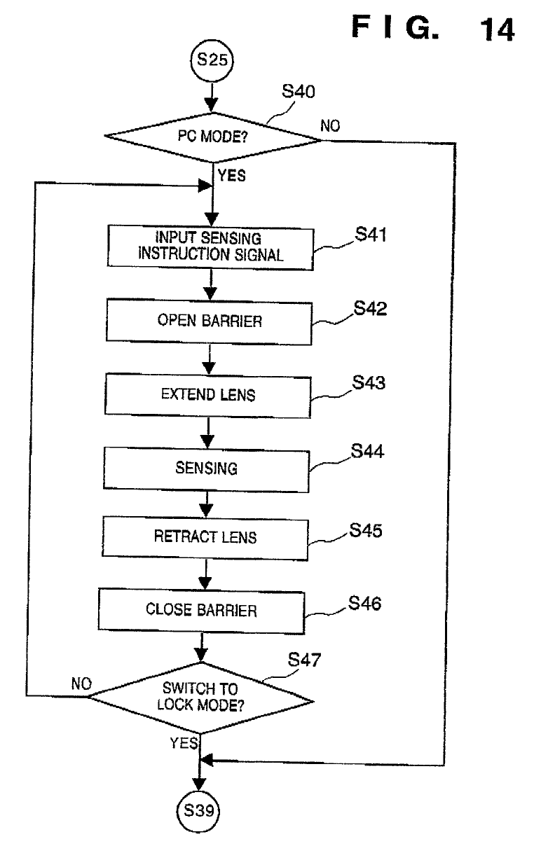

FIG. 14 is a flow chart showing the opening/closing operation sequence of the barrier 8, which is the same as FIG. 13 except for steps enclosed with the broken lines. The sequence is controlled by the CPU 17.

If it is determined in step S40 of FIG. 14 that the PC mode is set, the CPU 17 waits for a sensing instruction signal. If a sensing instruction signal is input (step S41), the CPU 17 opens the barrier 8 (step S42), extends out the optical block 2 from the retracted region to the extended region (step S43), and starts to sense images (step S44). After completing image sensings, the CPU 17 immediately pulls in the block 2 from the extended region into the retracted region, and closes the barrier 8 (step S46). If the mode is switched to the LOCK mode (step S47), the CPU 17 turns off the power supply (step S39) and completes the operation.

Although not shown in the illustration, the barrier 8 is kept closed and the block 2 is not extended from the retracted region, in a case where operations except for image-sensing, such as image-transfer operations in the PC mode, are being performed.

As described above, sensing is not only camera operation in the PC mode, so the barrier 8 is opened and the block 2 is extended only when an image is sensed. This prevents the lens as well as the optical block 2 of the camera from being broken.

<Control Procedure> . . . Third Example

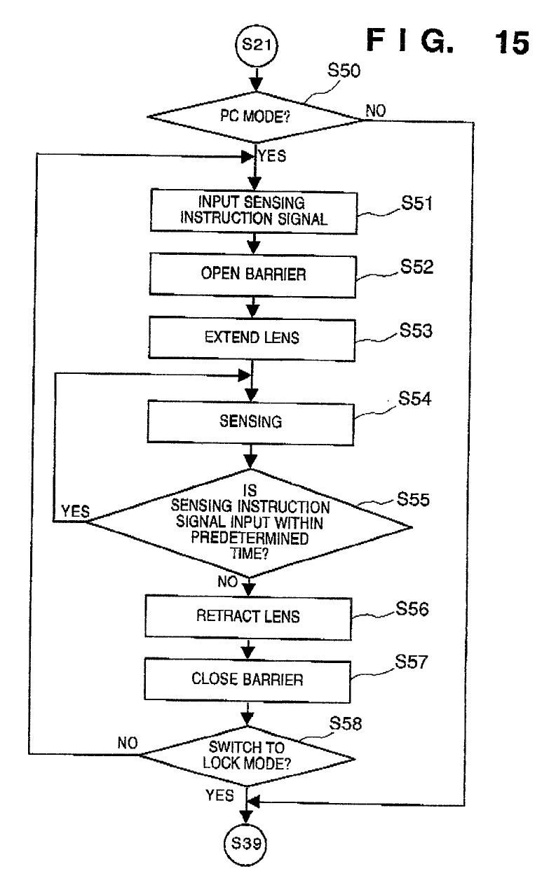

FIG. 15 is a flow chart showing the opening/closing operation sequence of the barrier 8, which is the same as FIG. 13 except for the steps enclosed with the broken lines. The operation is controlled by the CPU 17 as in the example of FIG. 14.

If the PC mode is set in FIG. 13 (step S50), the CPU 17 waits for a sensing instruction signal. If an image sensing instruction signal is input (step S51), the CPU 17 opens the barrier 8 (step S52), and extends out the block 2 from the retracted region to the extended region (image sensing region) (step S53), and starts image sensing (step S54). When the sensing is completed, an internal timer of the CPU 17 is initiated to measure the time. If an image sensing instruction signal is again input (step S55) within a predetermined time after the completion of the image sensing, the CPU 17 does not pull in the block 2 in the non image sensing region, and takes photographs (step S54). Elapse of the predetermined time is detected by the internal timer. If no image sensing instruction signal is input within the predetermined time after the sensing is complete, the CPU 17 pulls in the block 2 in the non-image sensing region (step S56), and closes the barrier 8 (step S57). If the mode is switched to the LOCK mode (step S58), the CPU 17 turns off the power supply (step S39) and completes the operation.

As described above, according to the embodiment of the invention, if a next image sensing instruction signal is input within the predetermined time, the optical block 2 is kept extended in the image sensing region. This prevents from extraneous extension and retraction operations of the block 2, and saves the power for the operations. Also, since sensing can be done as soon as an image sensing instruction signal is input, a camera with quick response speed can be provided. Furthermore, the block 2 is placed in he retracted region a the barrier 8 is closed when sensing is not continuously done, so the lens of the camera can be protected except when necessary.

The individual components shown in schematic or block form in the Drawings are all well-known in the camera arts ad their specific construction and operation are not critical to the operation or best mode for carrying out the invention.

While the present invention has been described with respect to what is presently considered to be the preferred embodiment, it is to be understood that the invention is not limited to the disclosed embodiments. To the contrary, the invention is intended to cover various modifications and equivalent arrangements included within the spirit and scope of the appended clam. The scope of the following claim is to be accorded the broadest interpretation so as to encompass all such modifications and equivalent structures and functions.

For examples, the present invention can be also applied to cameras having function of extending out and pulling in optical systems for focal length changer and/or for focussing.

The present invention can be applied to cameras that are allowed to extend out and pull in the optical system or block in the image sensing region. In those cases, the housing position of the optical system or block is, for example, defined as the most collapsed position.

Further, the present invention can be applied to an optical system or block such as view finder that is one used except for image sensing and is pulled in and/or extended out.

Furthermore, in the above embodiments, the external computer which controls the camera in the PC mode is connected to the camera, and the camera is controlled by the computer through the connection. Alternatively, the control may be achieved using wireless signal from the external computer.

Further, changing mode into the PC mode is made with the dial in the above embodiments. It is also proposed that the changing may be made in an automatic manner upon the connection of the camera to the computer. Specifically, in the alternative modification, it is detected that an external computer is connected to the camera, the CPU 17 automatically sets the camera into PC mode without user's manual operation.

Further, the embodiments as set forth comprise the PC mode as an external control mode. The present invention can be extended to other external control modes such as a remote control mode using a remote controller.

Further, the software and/or hardware configurations, for example, may be replaced or substituted in suitable manner.

Further, the present invention can be applied to a device unit comprising the entire or partial structure of the claimed apparatus or embodied apparatus. Furthermore, the invention may be applied to a system wherein they are combined with another unit, or to a component comprised of an apparatus.

Further, the present invention can be constituted of any combinations of the above described embodiments, as the occasions demand. Further, the present invention can be constituted of necessary components of any ones of the above described embodiments, as the occasions demand.

The present invention can be applied yet further to digital still cameras, video cameras, various types of cameras such as cameras using silver-salt films, any types of image sensing devices or optical devices except for cameras, and other types of devices. It can be further applied to a device which is applied to the cameras, optical devices and the other types of devices, or to any component comprising the cameras, the optical devices and the other types of devices.

What is claimed is:

1. An image sensing apparatus comprising:
a driving device moving an image sensing optical system to image sensing and non image sensing regions; and
a determination device determining whether said image sensing apparatus is set at least in an image sensing mode, or in an external control mode in which said apparatus is controlled by an external controller unit, said determination device determining an operation of said driving device in accordance with a determination result of said determination device.

2. An apparatus according to claim 1, wherein
in a case where said determination device determines that said image sensing apparatus is set in the external control mode, said determination device causes said driving device to drive said image sensing optical system to the image sensing region.

3. An apparatus according to claim 1, wherein
said determination device causes said driving device to drive said image sensing optical system to the image sensing region in response to a reception of an image sensing signal from the external controller unit, in a case where said determination device determines that said image sensing apparatus is set in the external control mode.

4. An apparatus according to claim 3, wherein
said determination device causes said driving device to drive said image sensing optical system to the non image sensing region, in response to a completion of an image sensing operation of said apparatus.

5. An apparatus according to claim 3, wherein
said determination device comprises a timer for causing said driving device to drive said image sensing optical system to the non image sensing region, a predetermined time period after a completion of an image sensing operation of said apparatus.

6. An apparatus according to claim 5, wherein
in a case where the image sensing signal is input again from the external controller unit during the predetermined time period, said determination device prevents said driving device from driving said image sensing optical system to the non image sensing region, after the predetermined time period has elapsed.

7. An apparatus according to claim 1, wherein said determination device positions said image sensing optical system in the non image sensing region, in a case where said determination device determines that said apparatus is set in the external control mode.

8. An apparatus according to claim 1, wherein
said determination device prevents said driving device from driving said image sensing optical system to the image sensing region, in a case where said determination device determines that said apparatus is set in the external control mode.

9. An apparatus according to claim 1, wherein
in a case where said determination device determines that said apparatus is set in the external control mode, said determination device causes said driving device to drive said image sensing optical system to the image sensing region in response to a completion of an image sensing operation of said apparatus.

10. An apparatus according to claim 1 wherein said determination device comprises a timer for monitoring whether a predetermined time period has elapsed after a completion of an image sensing operation of said apparatus, and causes said driving device to drive said image sensing optical system to the non image sensing region in response to said timer, in a case where said determination device determines said apparatus has been set in the external control mode.

11. An apparatus according to claim 10, wherein
in a case where an image sensing signal is input again from the external controller unit during the predetermined time period, said determination device prevents said driving device from driving said image sensing optical system to the non image sensing region after the predetermined time period elapses.

12. An apparatus according to claim 1, wherein
in a case where said determination device determines that said apparatus is set in a reproduction mode, said determination device positions said image sensing optical system in the non image sensing region.

13. An apparatus according to claim 1, further comprising:
an operation device for selectively setting said apparatus into at least either one of the image sensing and external control modes, said operation device being provided on an exterior of said image sensing device.

14. An apparatus according to claim 1, further comprising.
a signal processing device converting, in a case where said apparatus is set in the image sensing mode, an optical image formed by the optical system, into an electrical signal for photography.

15. An apparatus according to claim 1, wherein the non mange sensing region includes a position where said optical system is stored.

16. An apparatus according to claim 1, wherein the non image sensing region includes a predetermined position where the optical system is collapsed in a body of said image sensing apparatus.

17. An apparatus according to claim 1, wherein said determination device determines a mode controlled by an external computer as the external control mode.

18. An apparatus according to claim 1, wherein said driving device includes a motor.

19. An apparatus according to claim 1 further comprising a camera.

20. An image sensing apparatus comprising:
a driving device moving an image sensing optical system in extending and retracting directions; and
a determination device determining whether said image sensing apparatus is set at least in an image sensing mode, or in an external control mode in which said apparatus is controlled by an external controller unit, said determination device determining an operation of said driving device in accordance with a determination result of said determination device.

21. An apparatus according to claim 20, wherein
in a case where said determination device determines that said image sensing apparatus is set in the external control mode, said detention device causes said driving device to drive said image sensing optical system in the extending direction.

22. An apparatus according to claim 20, wherein
said determination device causes said driving device to drive said image sensing optical system in the extending direction in response to a reception of an image sensing signal from the external controller unit, in a case where said determination device determines that said image sensing apparatus is set in the external control mode.

23. An apparatus according to claim 22, wherein
said determination device causes said driving device to drive said image sensing optical system in the retracting direction, in response to a completion of an image sensing operation of said apparatus.

24. An apparatus according to claim 22, wherein
said determination device comprises a timer for causing said driving device to drive said image sensing optical system in the retracting direction, a predetermined time period after a completion of an image sensing operation of said apparatus.

25. An apparatus according to claim 24, wherein
in a case where the image sensing signal is input again from the external controller unit during the predetermined time period, said determination device prevents said driving device from driving said image sensing optical system in the retracting direction, after the predetermined time period has elapsed.

26. An apparatus according to claim 20, wherein
said determination device prevents said driving device from driving said image sensing optical system in the extending direction, in case where said determination device determines that said apparatus is set in the external control mode.

27. An apparatus according to claim 20, wherein
in a case where said determination device determines that said apparatus is set in the external control mode, said determination device causes said driving device to drive said image sensing optical system in the retracting direction in response to a completion of an image sensing operation of said apparatus.

28. An apparatus according to claim 20, wherein said determination device comprises a timer for monitoring whether a predetermined time period has elapsed after a completion of an image sensing operation of said apparatus, and causes said driving device to drive said image sensing optical system in the retracting direction in response to said timer, in a case where said determination device determines said apparatus has been set in the external control mode.

29. An apparatus according to claim 28, wherein
in a case where an image sensing signal is input again from the external controller unit during the predetermined time period, said determination device prevents said driving device from driving said image sensing optical system in the retracting direction after the predetermined time period elapses.

30. An apparatus according to claim 20, wherein
in a case where said determination device determines that said apparatus is set in a reproduction mode, said determination device prevents said driving device from driving said image sensing optical system in the retracting direction.

31. An apparatus according to claim 20, further comprising:
an operation device for selectively setting said apparatus into at least either one of the image sensing and external control modes, said operation device being pro-vided on an exterior of said image sensing device.

32. An apparatus according to claim 20, further comprising:
a signal processing device converting, in a case where said apparatus is set in the image sensing mode, an optical image formed by the optical system, into an electrical signal for photography.

33. An apparatus according to claim 20, wherein said determination device determines a mode controlled by an external computer as the external control mode.

34. An apparatus according to claim 20, wherein said driving device includes a motor.

35. An apparatus according to claim 20 further comprising a camera.

36. An image sensing apparatus comprising:
a driving device moving an image sensing optical system in image sensing and non image sensing regions; and
a determination device determining whether said image sensing apparatus is set at least in an image sensing mode, or in an image reproduction mode, said determination device determining an operation of said driving device in accordance with a determination result of said determination device.

37. An apparatus according to claim 36, wherein said determination device positions said image sensing optical system in the non image sensing region, in a case where said determination device determines that said apparatus is set in the image reproduction mode.

38. An apparatus according to claim 37, wherein
in a case where said determination device determines that said image sensing apparatus is set in the image sensing mode, said determination device causes said driving device to drive said image sensing optical system in the image sensing region.

39. An apparatus according to claim 36, wherein
in a case where said determination device determines that said image sensing apparatus is set in the image reproduction mode, said determination device prevents said driving device from driving said image sensing optical system in the image sensing region.

40. An apparatus according to claim 39, wherein
in a case where said determination device determines that said image sensing apparatus is set in the image sensing mode, said determination device causes said driving device to drive said image sensing optical system in the image sensing region.

41. An apparatus according to claim 36, wherein the non image sensing region includes a position where said optical system is stored.

42. An apparatus according to claim 36, wherein the non image sensing region includes a predetermined position where the optical system is collapsed in a body of said image sensing apparatus.

43. An apparatus according to claim 36, wherein said driving device includes a motor.

44. An apparatus according to claim 36 further comprising a camera.

45. An image sensing apparatus comprising:
a driving device moving an image sensing optical system in extending and retracting directions; and
a determination device determining whether said image sensing apparatus is set at least in an image sensing mode, or in an image reproduction mode, said determination device determining an operation of said driving device in accordance with a determination result of said determination device.

46. An apparatus according to claim 45, wherein
in a case where said determination device determines that said image sensing apparatus is set in the image reproduction mode, said determination device prevents said driving device driving said image sensing optical system in the extending direction.

47. An apparatus according to claim 46, wherein
said determination device causes said driving device to drive said image sensing optical system in the extending direction, in a case where said determination device determines that said image sensing apparatus is set in the image sensing mode.

48. An apparatus according to claim 45, wherein said driving device includes a motor.

49. An apparatus according to claim 45 further comprising a camera.
